(19) United States
(12) Patent Application Publication
(10) Pub. No.: US 2026/0273815 A1
(43) Pub. Date: Sep. 17, 2026

(54) HYBRID COMPOSITE STRUCTURE AND PROCESS FOR FORMING UTILIZING HIGH PRESSURE DIE CAST COMPONENTS WITH STRUCTURAL PLASTIC OVERMOLD

(71) Applicant: Martinrea International US Inc., Auburn Hills, MI (US)

(72) Inventors: Pat Walsh, Macomb, MI (US); Gavin Sheffer, Howell, MI (US); Peter C. Siefert, Harrison Township, MI (US)

(73) Assignee: Martinrea International US Inc., Auburn Hills, MI (US)

(21) Appl. No.: 19/561,817

(22) Filed: Mar. 10, 2026

Related U.S. Application Data
(60) Provisional application No. 63/769,845, filed on Mar. 11, 2025.

(51) Int. Cl. B29C 45/14; B29K 705/02; B29L 31/30

(52) U.S. Cl. CPC B29C 45/14467; B29C 45/14819; B29C 2045/14131; B29K 2705/02; B29L 2031/3002

(57) ABSTRACT

A process, article and assembly for joining a plurality of individual castings into a hybrid composite, including providing a plurality of individual castings and arranging the castings in an arrayed fashion, transporting the arranged castings into an injection molding machine, and injecting a plasticized material between and around the castings for forming a single hybrid structure. Additional steps include the castings being provided as aluminum castings. The step of injecting a plasticized material further includes utilizing a High Pressure Die Casting (HPDC) technology with thermoplastic injection molding or over-molding techniques to form the single hybrid structure. The single hybrid structure further includes forming any of a vehicle frame, chassis or underbody. Alternatively, the step of forming a single hybrid structure can include forming an EV battery tray.

### CROSS REFERENCE TO RELATED APPLICATIONS

The present application claims the priority of U.S. Ser. No. 63/769,845 filed Mar. 11, 2025.

### FIELD OF THE INVENTION

The present invention relates generally to joining techniques for combining plastic and metal components into a composite structure. More specifically, the present invention teaches a process and related article and assembly employing a unique joining approach utilizing high-pressure die cast machinery in the formation of large mega-casting hybrid assemblies, such as for use in the electric vehicle market by which traditional original equipment manufacturer body shop welding and joining techniques are eliminated in favor of combining together large-scale castings via thermoplastic injection molding techniques.

### BACKGROUND OF THE INVENTION

The rise of electric vehicles in the market and the need to offset the increased cost and mass of EV (electric vehicle) and HV (hybrid vehicle) batteries and their protective structures has original equipment manufacturers (OEM's) looking for ways to balance the cost/mass equation driving innovation, part consolidation and productivity improvements. Aluminum Mega-castings (also known as Giga-castings) bring a new trend to the market disrupting the mainstream, legacy body-in-white or BIW assembly generally defined as a stage in automobile manufacturing in which a car body frame has been joined together before painting and before integration of motor chassis sub-assemblies and trim features such as glass, door locks, handles, seats, upholstery, electronics, etc., along with joining of multiple parts by transforming to a single large high pressure die cast (HPDC) structure. HPDC casting contemplates injecting such as a molten metal into a pre-designed mold at high pressure within a die cavity, such as with the assistance of pressure. This paradigm shift requires significant up-front investment in mega-HPDC presses and facilities to accommodate the workflow and maintenance of these mega-sized presses and tooling.

The advent of the mega casting in the vehicle body structure has revolutionized the vehicle manufacturing environment offering new efficiencies in traditional body shop assembly, reduced manufacturing footprint, and the enablement of modular build. The barrier to entry remains the large up-front start-up costs and the tie of traditional OEM's and Tier 1's with existing assets and infrastructure. Casting of a single piece aluminum underbody HPDC structure requires a mega press of at least 6000 tons or greater. These types of presses are not prevalent in most OEM and Tier 1 footprints. Large HPDC presses (<5000 tons) do exist and this is where the concept of this invention finds a bridge of opportunity in this rising era of mega castings.

Addressing the prior art, Rink U.S. Pat. No. 5,842,265 teaches a process and device for producing bonded plastic metal parts in the cavity of a modified injection-molding tool by a combination of metal-joining techniques and conventional injection molding processes, which includes pressing individual metal sheets and injection molding a thermoplastic material to bond the sheets to one another.

Ilse, U.S. Pat. No. 7,025,921 (ITM Gmbh) teaches the production of a hybrid component, in which a piece of metal sheet (1) is a least partly coated with plastic by injection molding, following which it is placed into an injection mold half such that a first mold cavity is located opposite an upper side of the metal sheet and a second mold cavity opposite an under side of the metal sheet which are cut off from each other. A plastic is provided by a first sprue to form a flat coating on the upper side, following which the underside is treated by a second sprue to produce a reinforcing structure connected to the metal sheet.

Chinese Reference CN 106657446 teaches an in-mold injection molding combining a shell of an aluminum alloy and a plastic connecting piece.

Staargaard US 2006/0121246 (G.E.) teaches a method of attaching plastic to a metal substrate including molding a plastic component about a hydroformed metal section.

Eipper US 2007/0131012 (Daimler Chrysler AG) teaches a hybrid component having a sheet metal body and a plastic body injection-molded onto the sheet-metal body. The sheet-metal body is produced by cutting, edging, stamping and/or plastic forming a plate-shaped metal sheet, and has a surface coating on at least one visible side, as well as at least one uncoated cut or stamped edge. The plastic body is injection molded so that it seals the at least one uncoated or stamped edge of the sheet metal body and stiffens the sheet metal body.

Finally, Kikumori U.S. Pat. No. 11,198,237 (Olympus Corp) teaches an insert molding method including installing a first insert piece between a first mold and a second mold such that a smallest distance in a gap between the first insert piece and the first mold is smaller than a smallest distance in a gap between the first insert piece and the second mold. The first insert piece includes a first through-hole of which width is larger than the smallest distance in the gap between the first insert piece and the first mold. A resin is supplied to a mold gap between the first insert piece and the first mold or the second mold, thereby to fill the mold gap with the resin while the first insert piece and the first mold abut each other.

### SUMMARY OF THE INVENTION

The present invention discloses a novel article process, article and assembly in the joining a plurality of individual castings into a hybrid composite, such as without limitation incorporated into a vehicle structure. The forming process includes the steps of providing a plurality of individual high pressure die castings, arraying the castings in a desired fashion including incorporating interlock features established between mating end locations of the castings for mechanically coupling the same together on a suitable fixture prior to molding, transporting the castings and fixture for insertion into an injection molding machine (typically an injection molding die press), and injecting a plasticized material between and around the castings for forming a single hybrid structure. Additional steps include the HPDC castings being provided as aluminum castings.

The supporting fixture positions the first and second HPDC components in an arrangement in which the components define a predetermined alignment relative to one another with interlock features mechanically coupling together the first and second HPDC components. The fixture operates to maintain in position the metal die-cast parts during the high-pressure plastic injection phase, thereby avoiding any of variable wall thickness in the final plastic over-mold, instances of flashing in which the molten plastic escapes into gaps around the metal insert and mold damage in instance of misalignment of a metal part which can be crushed when the mold closes. Without limitation, interior features within the mold itself (like pins or shaped pockets) can “nest” the part securely once it is placed upon the fixture.

Other considerations include thermal expansion, since HPDC parts are often aluminum or zinc, the fixture and mold must account for the metal's expansion when it comes into contact with hot molten plastic. The fixture ensures the part is seated in the mold's moving or stationary platen before the associated clamping unit applies tons of force to seal the halves. Once the plastic solidifies, ejector pins push the combined metal-and-plastic hybrid component out of the mold.

The step of injecting a plasticized material includes utilizing High Pressure Die Casting (HPDC) technology with thermoplastic injection molding or over-molding techniques in order to form a single hybrid structure, such as which can be incorporated into a vehicle frame, chassis or underbody. Alternatively, the step of forming a single hybrid structure can include without limitation forming an EV battery tray.

The concept of combining High Pressure Die Casting (HPDC) technology with thermoplastic injection molding or over-molding techniques to form a single hybrid structure (also termed a plastic metal mega-casting hybrid assembly) is considered novel, such as for incorporation into vehicle frame, chassis or underbody applications. In one non-limiting application, the process provides for injection molding multiple aluminum HPDC components together into a single overall structure to provide a lightweight option for integrating into EV vehicles (such as to compensate for the cost and weight of the EV batteries and their associated support structures).

The present invention provides the additional benefit of eliminating the need for adhesives and additional mechanical fasteners such as conventional welding or self-piercing rivets (SPR's) for joining two or more layers of a material without the requirement of predrilled or punched holes, or the use of flow drilling screws (FDS) for joining materials such as dissimilar aluminum alloys according to existing thermal-mechanical joining process.

As also understood, combining smaller and midrange HPDC assemblies with injection molding applications provides for both cost and manufacturing efficiencies and avoids the need for massive or mega presses (such as requiring several thousand tons of force application and which are outside of the budget of many OEM's), as well as eliminating the need for traditional OEM body shop welding and joining techniques for fabricating together multiple parts.

The present invention accordingly provides an opportunity for utilization of existing large casting HPDC assets while achieving a single end item mega hybrid module/assembly through a unique process of insert-molding aluminum HPDC components in a plastic injection molding process for the purpose of achieving a single hybrid structure through the unique joining of two or more individual aluminum HPDC pieces. In this fashion, the present invention provides the ability to define a unique joint configuration of metal and plastic which includes metal-to-metal interface, as well as metal to plastic interface of the joined components.

### BRIEF DESCRIPTION OF THE DRAWINGS

Reference will now be made to the attached drawings, when read in combination with the following detailed description, wherein like reference numerals refer to like parts throughout the several views, and in which:

FIGS. 1A-1C present a progression of illustrations for creating a plastic metal mega-casting hybrid assembly joining a plurality of individual large castings through the use of metal insert injection molding;

FIGS. 2A-2D present a progression of illustrations of a related joint hybrid concept for joining a plurality of aluminum high pressure castings into a hybrid joint assembly;

FIG. 3 is a perspective view of a pair of HPDC castings which are joined in a plastic-hybrid fashion with the thermoplastic molded material applied around the opposing interlock features according to the process and assembly of the present invention for securing together the first and second HPDC castings;

FIG. 4 is a cutaway view taken along line 4-4 of FIG. 3 and depicting a lower mating interface established between the interlock end geometry of the HPDC castings for receiving flow through of plastic through the aligning holes formed in the castings for binding together the hybrid casting;

FIG. 5 is a cutaway view taken along line 5-5 of FIG. 3 and depicting an upper mating interface between the aligning holes in the overlapping interlock profiles of the HPDC castings for receiving the flow through plasticized material associated with the thermoplastic molding operation;

FIG. 6 presents an exploded view of the plastic/metal hybrid mega casting depicted in FIG. 3 and better showing the engaging aspects of the interlocking end profiles associated with the HPDC castings over which is applied the thermoplastic molded material;

FIG. 7 illustrates an enlarged view of the interlocking opposing end features of the HPDC castings and depicting the plurality arrangement of the through-holes which align upon the end-overlapping arrangement of the interlocking features for facilitating plastic flow-through during the over-molding process for forming bolt-like members to secure together the HPDC castings;

FIG. 8 depicts a downward looking partial plan view of an interlocking interface established between the interlock component and the adjoining end profiles of the first and second HPDC casting and including a T-rib end structure for facilitating engagement with the plastic over-mold;

FIG. 9 presents an underside rotated view of the plastic/metal hybrid mega casting, such as shown previously in FIG. 3, and better depicting a reinforcing plastic over-mold rib profile incorporated into the completed hybrid assembly;

FIG. 10 is a perspective view of a completed plastic/metal hybrid mega casting according to a further non-limiting embodiment and produced according to the process and assembly of the present invention, again including an injection over-mold structural plastic securing together the first and second HPDC castings along with forming additional tub-shaped interior portions from the thermoplastic over-mold material;

FIG. 11 presents an exploded perspective of the first and second HPDC castings and better depicting the configuration of the opposing end interlocking features configured in the end and intermediate crosswise extending portions of the castings;

FIG. 12 presents a succeeding view to FIG. 11 and depicting the repositioning of the interlocking configurations in the opposing end profiles of the castings prior to overlapping engagement;

FIG. 13 presents a plan view of the opposing interlocking end extension profiles of FIG. 11 and illustrating in phantom the underside ribbed structure of the castings which permit the overlapping engagement shown in FIG. 12;

FIGS. 14-24, presented are a succession of three dimensional and cutaway views showing a variety of overlapping interlocking profiles established between the end extensions of the first and second HPDC castings, and including depictions of flow-through of the injection molded plastic for establishing the hybrid structure;

FIG. 25 is an overhead plan view of the first and second HPDC components arranged in overlapping engagement prior to being secured to the mounting fixture and transferred to the injection molding press operation for introducing the thermoplastic material;

FIGS. 26A-26B depict an HPDC casting operation for producing each of first and second HPDC castings depicting the desired interlocking end profiles;

FIG. 27 presents an exploded view of a three piece casting according to a non-limited alternate embodiment and depicting two outboard HPDC casted rails connected to a third middle piece defining a close out panel and including a jigsaw interlocking end configuration;

FIG. 28 provides a further succeeding view to FIG. 27 and showing the jigsaw interlocking of the middle piece to the end HPDC end rails;

FIG. 29 is a succeeding view to FIG. 28 and showing plastic over-molding of the close-out panel to the HPDC rails;

FIG. 30 depicts an isometric view showing an over-molding process/hybrid structure according to a further embodiment incorporating insert-molded fastening elements, including but not limited to threaded inserts, knurled nuts, studs, bosses, and similar metallic components, which may be positioned within the mold cavity prior to injection such that the structural plastic material encapsulates the inserts, thereby forming integrated attachment points within the hybrid structure;

FIG. 31 presents an overhead plan view of a variant of the present invention in which first and second “L” shaped castings are joined together with the over-molded plastic forming either of a continuous or semi-continuous longitudinal beam;

FIG. 32 presents an initial view of a pair of HPDC castings prior to fixturing to an injection molding tool according to a first variant;

FIG. 33 presents a succeeding view to FIG. 32 and representatively showing the castings fixtured to one half of an injection molding tool which, upon assembly of the second half of the fixture, depicts the entire mega-casting positioned within and between the tie bars of the injection mold tool;

FIG. 34 depicts a pair of robotic arm and actuators for placement of the HPDC castings which are held in place by fixtures in the form of suitable die clamps for securing the castings upon the mold tool surface;

FIG. 35 depicts a succeeding view of FIG. 34 with the tool/press closed against the fixtured HPDC parts;

FIG. 36 depicts a further succeeding view of the tool reopened to reveal the injection molded connection of the HPDC parts or components in order to form the hybrid structure;

FIG. 37 depicts the hybrid structure of FIG. 36 removed from the mold;

FIG. 38 presents a perspective view of an alternate variant of over-molding operation in which the HPDC castings are supported on a standalone fixture located between the injection-mold tool halves, with the entire mega-casting remaining inside of the assembly tie bars;

FIG. 39 depicts a third variant representation of an over-molding operation for joining the HPDC castings into a hybrid structure and depicting the mega-castings supported upon the injection molding press such that they extend outside of the IM press tie bars;

FIG. 40 is a succeeding view to FIG. 39 depicting the HPDC castings secured to the mold press via mounting fixtures prior to molding; and

FIG. 41 presents a further succeeding view to FIG. 40 with the second mold tool applied over the fixtures supported HPDC castings concurrent with the injection molding operation for forming the hybrid structure.

### DETAILED DESCRIPTION OF THE PREFERRED EMBODIMENTS

With reference to the attached illustrations, the present invention discloses a unique joining approach utilizing high-pressure die cast machinery in the formation of large mega-casting hybrid assemblies, such as for use in the electric vehicle (EV) market by which traditional original equipment manufacturers (OEM) body shop welding and joining techniques are eliminated in favor of combining together large-scale castings via thermoplastic injection molding techniques such as in forming a battery tray or other vehicle support structure, such as for compensating for the weight of the EV batteries.

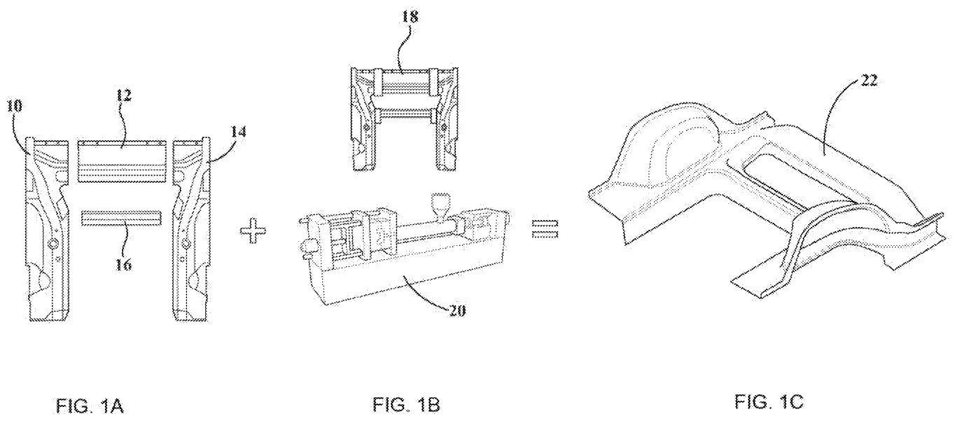

With reference initially to FIGS. 1A-1C, presented is a progression of illustrations for creating a plastic/metal mega-casting hybrid assembly joining a plurality of individual large castings (also termed HPDC castings), through the use of an injection molding die press. In one non-limiting application, the process provides for injection molding (IM) multiple aluminum HDPC components together into a single overall structure to provide a lightweight option for integrating into EV vehicles, such as to compensate for the cost and weight of the EV batteries and their associated support structures.

The first and second HPDC components are produced in a high-pressure die casting machine incorporated into a high-speed manufacturing process where molten aluminum is forced into a steel mold (die) at extreme pressures, typically between 10,000 and 20,000 psi. Key machine components include the die mold which define two halves of hardened tool steel that form the casted part shape and which are clamped together by a “locking end” rated for hundreds or thousands of tons of force.

Other features include a cylinder and piston assembly that receives and injects the molten metal, hydraulic accumulators in the form of pressurized gas systems that provide the massive bursts of speed and force needed for the injection and ejector pins mounted on a plate to push the finished casting out of the mold without damage.

As shown in FIG. 1A, a series of individual large castings are provided at 10, 12, 14 and 16 which, upon being arrayed in the desired configuration 18, are transported into an injection molding machine or operation (see as generally represented by injection molding press at 20 in FIG. 1B), during which a thermoplastic or composite material (this term generically provided to include any suitable plastic or like material not limited to a nylon material which is injected in a molten and highly pressurized manner in order to bind together the individual castings into a completed unitary structure, at 22 in FIG. 1C, which defines a plastic metal mega-casting hybrid assembly.

The injection molding (IM) press or tool 20 is representatively depicted in a simplified manner and, as will be further described in succeeding embodiments, exhibits a mold cavity with first and second opposing and re-closable halves, within or between which are secured the HPDC components via fixtures.

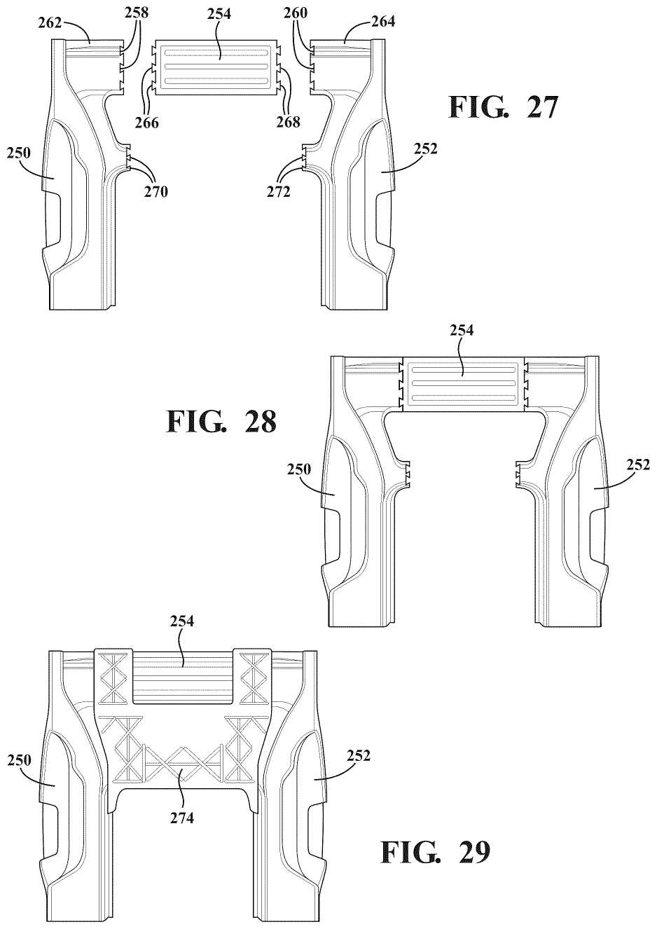

Without limitation, selected castings (including the end member 12 or intermediate cross member casting specifically shown at 16) can also be over-molded or substituted by an over-molded plasticized material as desired within the scope of the present invention (reference subsequently being made to the alternate variants of FIGS. 27-31). In this manner, the present invention uniquely combines a metal casting (such as including an aluminum) with a thermoplastic injection molded material formed into a lightweight single hybrid structure. As will be subsequently described, a suitable conveying structure is further employed for transferring the castings which are pre-arranged, to transport the large HPDC castings 10-16 to the succeeding injection molding operation 20.

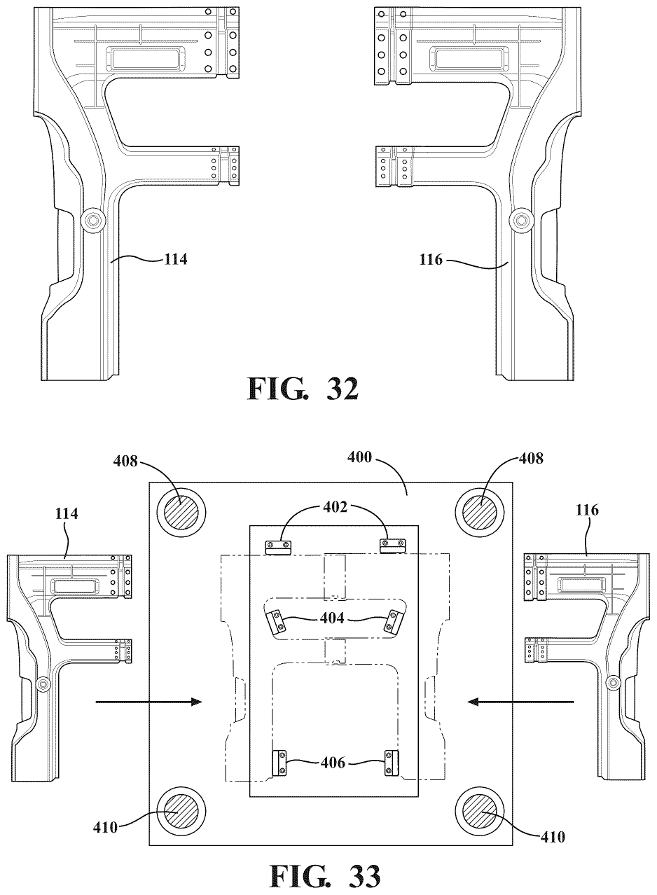

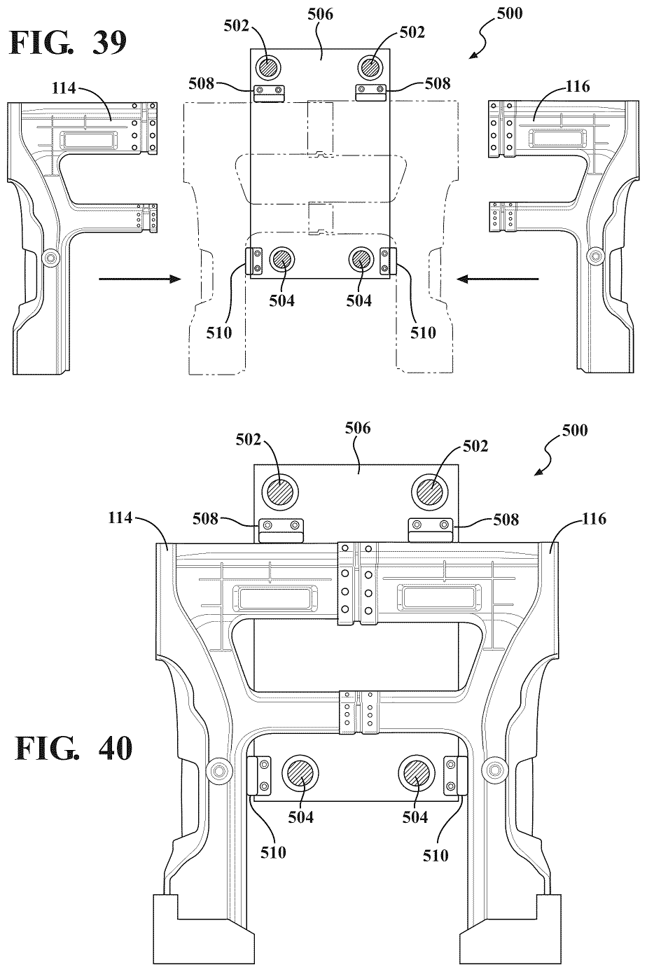

As will be further described, it is envisioned and understood that the injection molding operation can be modified to the extent necessary in order to over-mold the entire arranged casting within a defined cavity enclosure (see in particular subsequent assembly variants of FIGS. 32-38 in which the mega-casting is positioned entirely within the tie bars of the molding tool). Alternatively, and depending upon the size of the hybrid structure to be formed, the mega-casting can extend outside of the tie bars and the constraints of the injection molding process (see FIGS. 39-41), with other molding or over molding techniques also being envisioned in which sections or portions of the hybrid formed structure can be successively molded in order to achieve a similar finished product.

The injection molding tool 20 as described herein is typically in the form of an injection molding (IM) press that operates by melting plastic pellets fed by a hopper and forcing the molten plasticized material under high pressure into the mold cavity within which are positioned the fixtured HPDC components, where the material cools and solidifies into a finished part. The press consists of a clamping unit that holds the mold shut and an injection unit which heats and injects the plasticized material (such as including without limitation a heated and molten nylon or like material).

As will be subsequently described with reference to the specific tooling and process applications, the injection molding press includes each of the hopper (which is a container where raw plastic/resin pellets are fed into the machine) and an injection unit (also termed a barrel and screw) which uses heater bands and a rotating screw to melt the plastic, mixing it before injecting it into the mold. Other components include a fixturing unit (platens/clamp) which functions to holds the two halves of the mold together with significant force to counteract the high pressure of the injection process.

As further noted, the mold is a custom-engineered tool, usually of steel or aluminum, that defines the shape of the hybrid structure to be produced. Upon the hybrid molding being sufficiently cooled, an ejection system including hydraulic or mechanical actuated structure expels the finished part out of the mold.

In operation, the injection molding cycle operates by the machine closing the two halves of the mold up on them being clamped together around the previously formed and fixtured HPDC components with the interlock features engaged, following which the associated screw of the press rotates to move the molten plastic in pressurized fashion to force the material within the mold cavity, whereupon the plastic cools and solidifies within the mold. Upon completion of the cycle, the clamp opens, and any collection of pins or plates associated with the ejection mechanism pushes out or expels the finished hybrid mega casting.

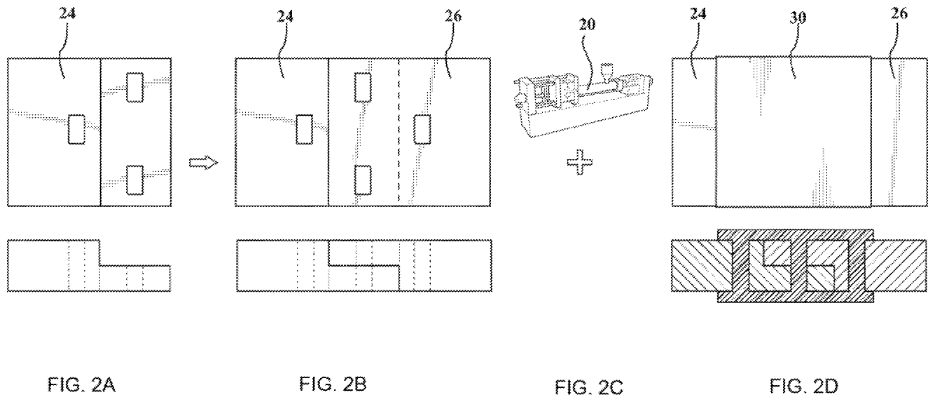

FIGS. 2A-2D reference a related hybrid joining concept for taking a plurality of aluminum HP castings (representatively shown at 24 in each of top and side plan view in FIG. 2A) and present a progression of illustrations for joining aluminum high pressure castings into a hybrid joint assembly. As further depicted in FIG. 2B, any plurality 24/26 of the castings can be arrayed in any desired configuration, following which they are transported, at FIG. 2C, into a suitable injection molding machine 20 (similar to as previously referenced in FIG. 1B). Finally, at FIG. 2D, the completed hybrid item is shown with plasticized joint 30 injection molded around the aluminum castings 24/26 which defines a unique process of insert-molding aluminum HPDC components in a plastic injection molding process for the purpose of achieving a single hybrid structure through the joining of two or more aluminum HPDC pieces.

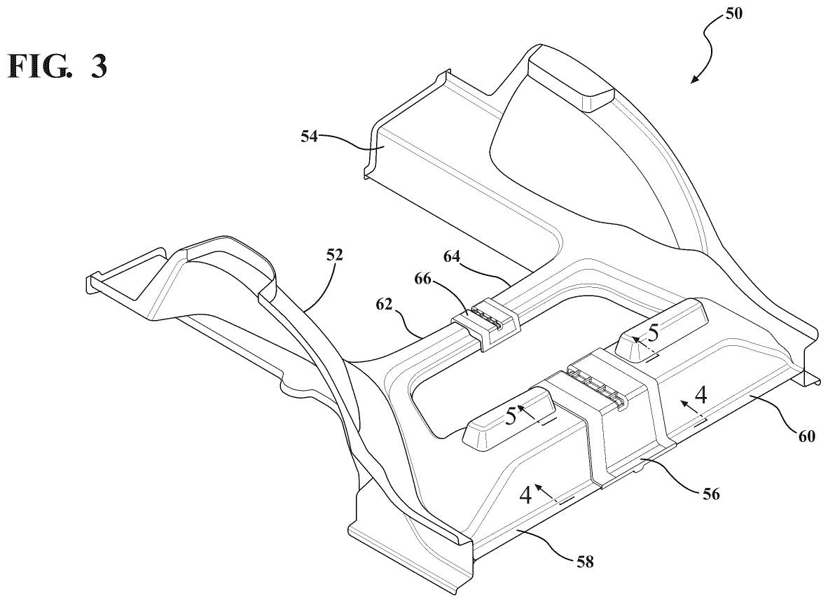

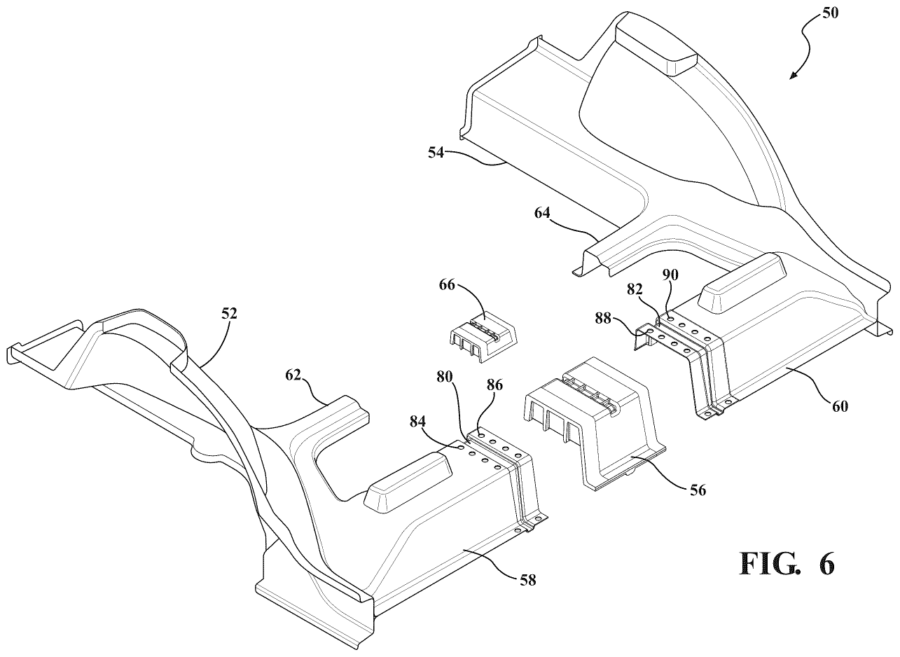

Proceeding to FIG. 3 a perspective view is generally shown at 50 of a plastic/metal hybrid mega casting produced according to the process and assembly of the present invention and including first 52 and second 54 HPDC castings, along with an over-molded material 56 applied over the opposing interlocking configuration (see also exploded view of FIG. 6) within the injection molding press for securing together the castings. As will be further described, the present invention contemplates the interlock component being provided in a preferred embodiment as opposing and interlocking end profiles configured in the HPDC castings, however and also envision the addition of a separate element for securing together the main HPDC castings prior to the IM over-molding operation being performed.

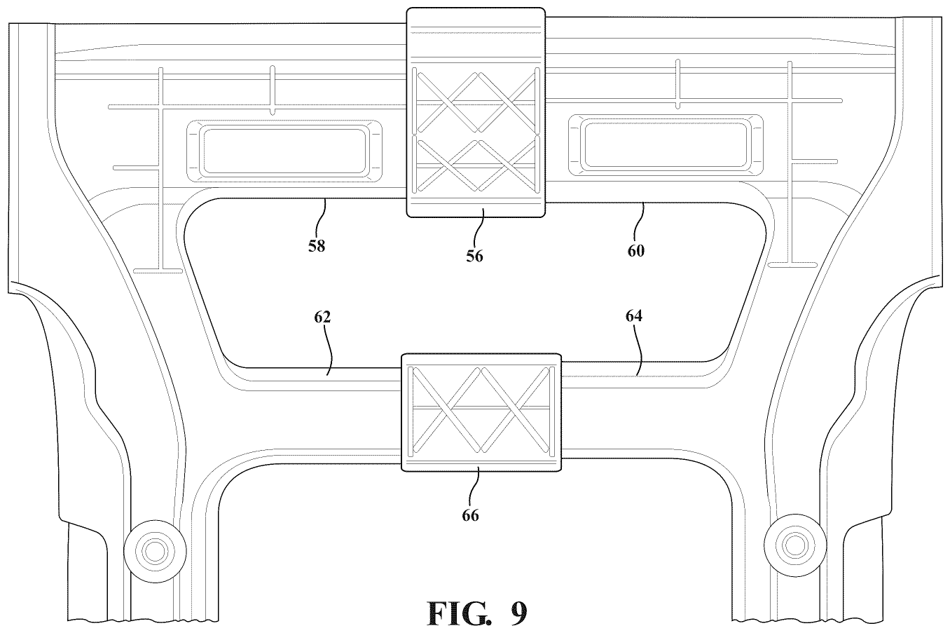

The HPDC castings 52/54 shown in FIGS. 3 and 6 can include any desired three dimensional formed shape which can include integrated end extensions 58/60 (these further again defining the interlocking opposing end features 80/82 as shown in FIG. 6), as well as exhibiting intermediate end extensions 62/64 shown in cutaway in FIG. 3 (and such as which define additional over-molded material 66 depicted in the underside view of FIG. 9 which can be molded around an additional arrangement of interlocking opposing end features not shown). As further shown in FIG. 9, the over-molded portions 56 and 66 include any incorporated rib profile or the like which contribute to the desired reinforcement provided to the hybrid structure.

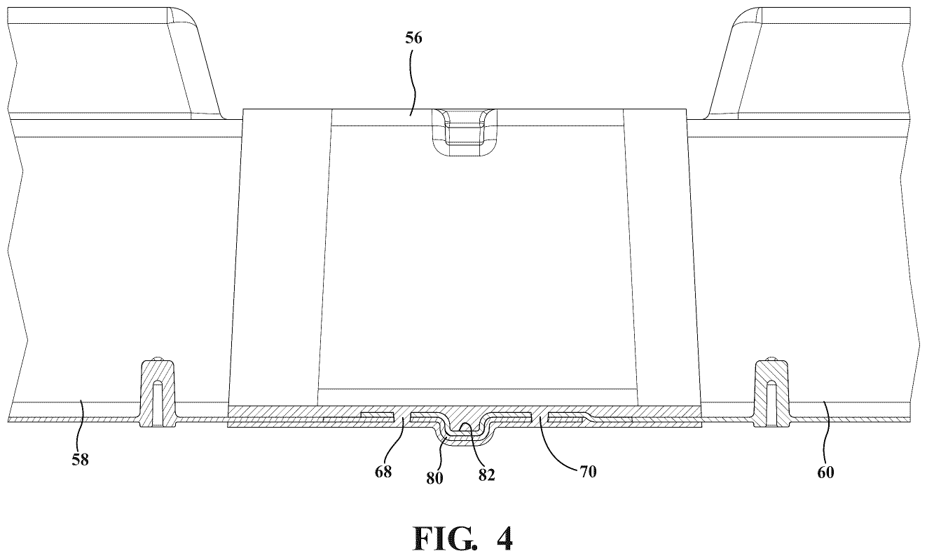

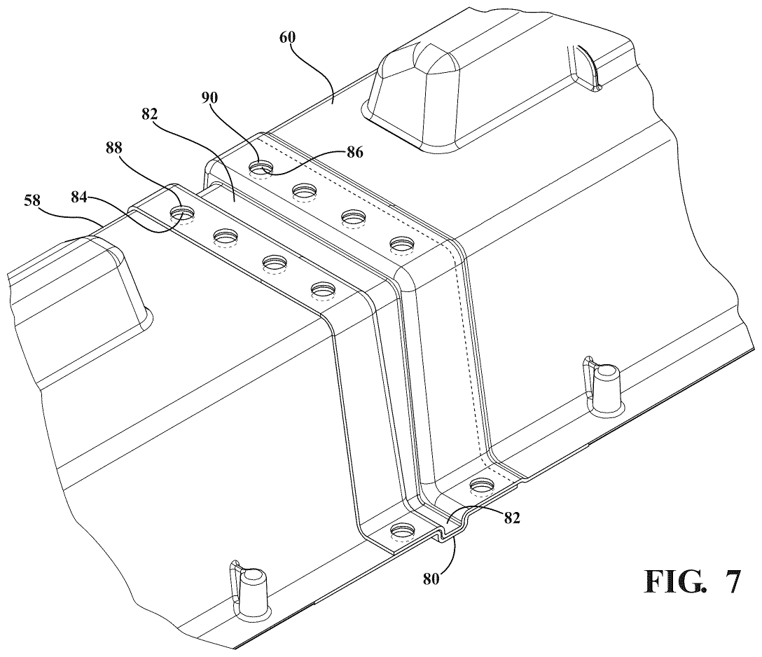

FIG. 4 is a cutaway view taken along line 4-4 of FIG. 3 and depicting a lower mating interface established between the interlocking profiles of HPDC opposing portion 58/60 and around which is molded the plasticized/nylon material 56. As will be further depicted in succeeding FIGS. 6-7, through holes are formed in the opposing end profiles of the castings to allow for flow through of the over-molded plastic, and such as representatively depicted by plasticized locations 68 and 70 corresponding to the material flow-through associate with the aligning aperture profile of FIG. 7 overlapping surfaces of the interlock component and HPDC castings. As will be further described, the interlock features described herein may include any geometry that provides mechanical engagement between adjacent casting prior to over-molding and such as which may be orientated in order to resist separation along the or more axes as well as serving as self-locating elements during orientation upon the fixtures prior to advancing to within the IM press mold cavity.

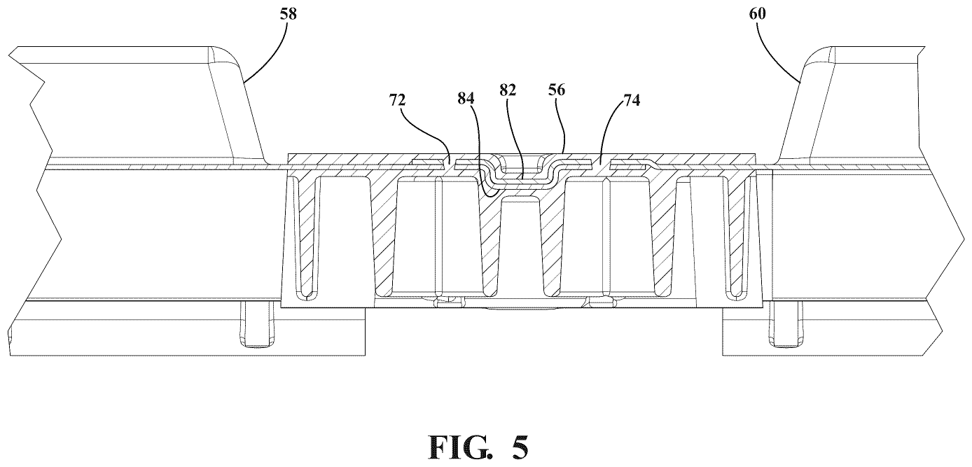

FIG. 5 is a cutaway view taken along line 5-5 of FIG. 3 and depicting an upper mating interface between the interlocking end features of the HPDC castings 58/60 about which the IM molded material 56 is applied, and showing a further arrangement of through plasticized flow-through locations 72/74 formed between the interlock component and castings to allow for flow through of the over-molded plastic 56 at a complementing location to the lower overlapping locations 68/70 in FIG. 4.

FIG. 6 presents an exploded view of the plastic/metal hybrid mega casting depicted in FIG. 3 and illustrating plasticized material 56 corresponding to the IM over-mold which is applied over the opposing interlocking features 80 and 82 exhibited upon the end portions of the respective HPDC components 52/54 and for securing together the first and second HPDC components.

FIG. 7 illustrates an enlarged sectional opposing end view of the interlocking end features 80/82 for securing together the opposing extending portions 58/60 of the HPDC castings. Also depicted is an arrangement of aligning apertures see at 84/86 associated with end profile 80 of first casting end extending portion 58 and further at 88/90 associated with end profile 82 of second casting end extending portion 60. As shown, the respective pairs of apertures 84/86 and 88/90 align upon overlapping contact of the interlocking features 80/82 such that, and upon subsequent IM of the over-mold plasticized material 56, the plasticized material flows and extends through the apertures or through holes in order to create a plastic-metal joint which unifies the first 52 and second 54 HPDC components into a single large hybrid structural assembly which is sized and configured to replace a conventional mega-cast vehicle structure.

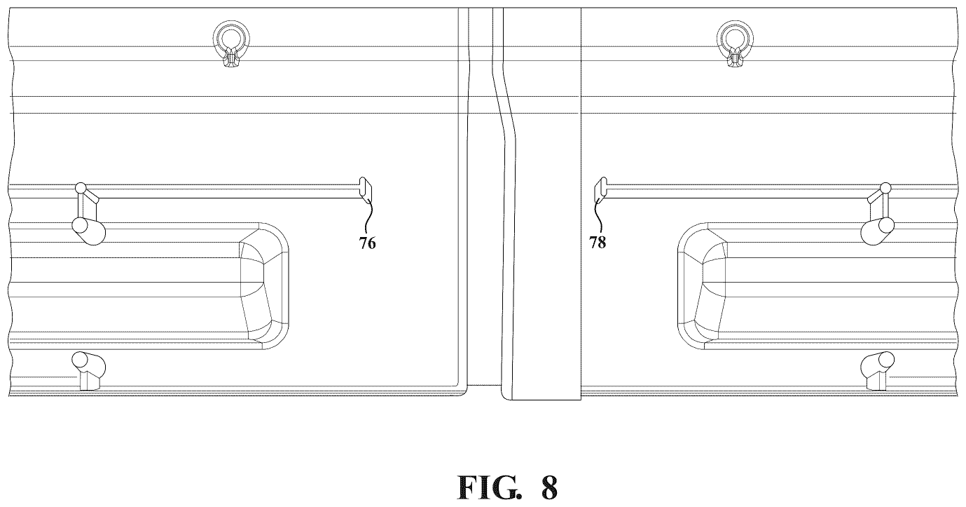

FIG. 8 depicts a downward looking partial plan view of an interlocking interface established between the adjoining end profiles 80/82 and including a T-rib end structure, see at 76 and 78, for facilitating engagement with the plastic over-mold material 56.

FIG. 9 presents an underside rotated view of the plastic/metal hybrid mega casting, such as shown previously in FIG. 3, and better depicting the arrangement of the reinforcing plastic over-molded material areas 56/66, each further including such as a rib profile incorporated into the completed hybrid assembly.

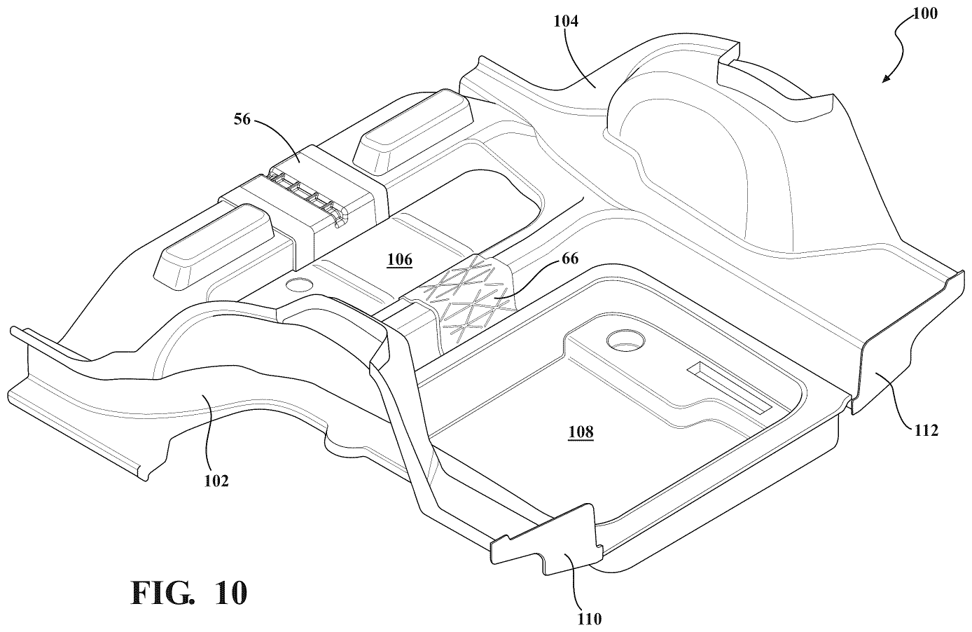

FIG. 10 presents a perspective view of a completed plastic/metal hybrid mega casting, see generally at 100, according to a further non-limiting embodiment and produced according to the process and assembly of the present invention, and which again includes an injection over-mold structural plastic (mirroring the over-molded portions 56/66 shown in FIG. 9) for securing together reconfigured first 102 and second 104 HPDC castings. Also depicted are additional injection molded components which can be included in the IM process and are illustrated by each of an injection molded close out plate or cover 106, along with an IM molded storge tub 108.

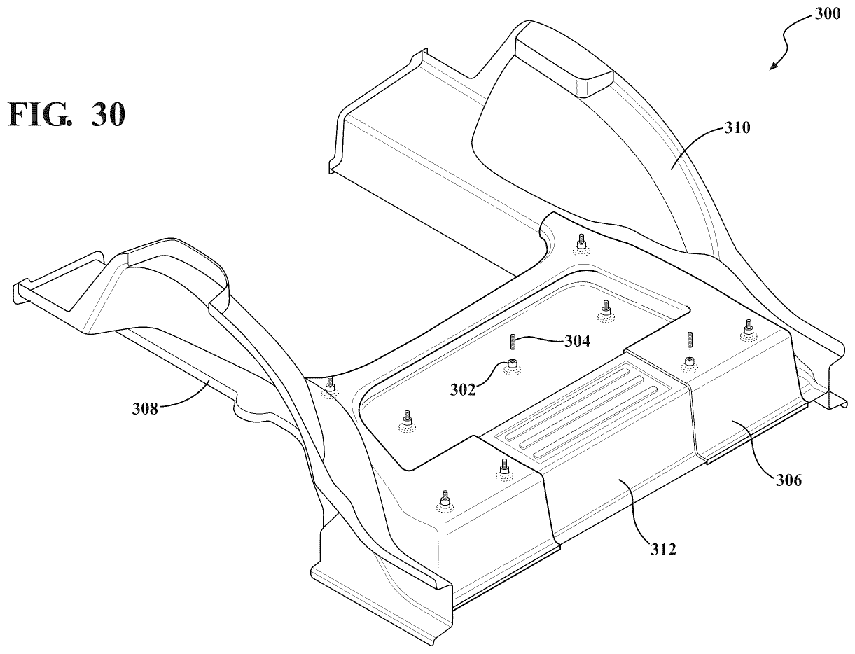

Without limitation, the injection molded plastic can include a nylon or other like material and further depicted are IM bumper mounts 110/112 associated with the hybrid vehicle structure 100. Without limitation, and as also depicted in subsequent FIG. 30, over-molded exterior features can also include any of fastener or fastener receiving nuts, fascia mounts, sensor brackets, spare tire winch attachments, aero shield attachments, and interior features including any of storage tubs, spare-tire wells, load floor attachments, trim attachments, and seat attachments.

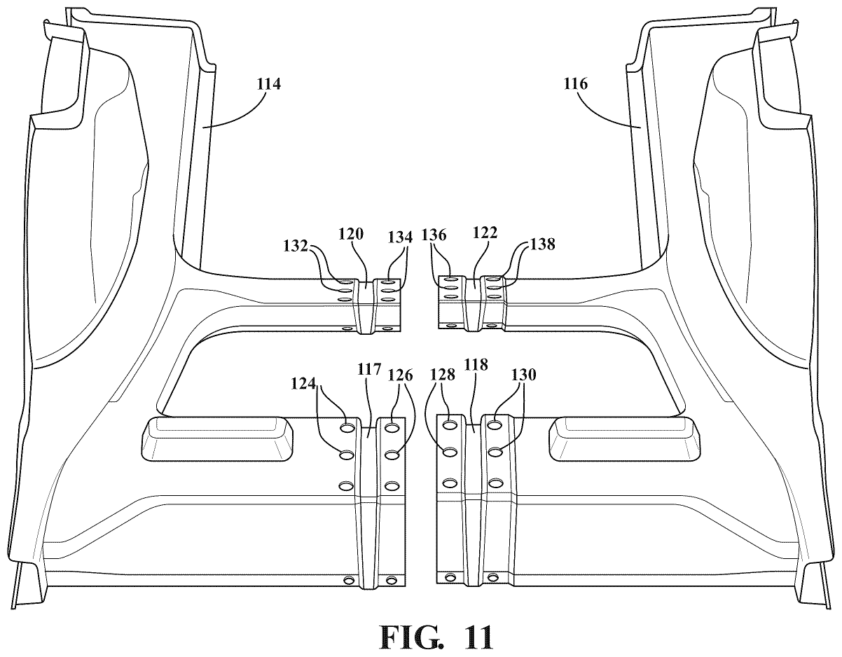

FIG. 11 presents an exploded perspective of first 114 and second 116 HPDC castings similar to as previously shown in FIG. 3 et seq. according to a related variant of the present invention and better depicting the configuration of the opposing end interlocking features configured in the end (at 117/118) and intermediate (at 120/122) crosswise extending portions of the castings 114 and 116. As previously described in related FIG. 6, overlapping pluralities of apertures are configured along each of the interlocking end profiles (see at 124/126 and 128/130 for end opposing interlocking profiles 117/118 and further at 132/134 and 136/138 for intermediate opposing interlocking profiles 120/122) which, upon assembly, define the through apertures for receiving the flow-through of the IM molded material (not shown in this view).

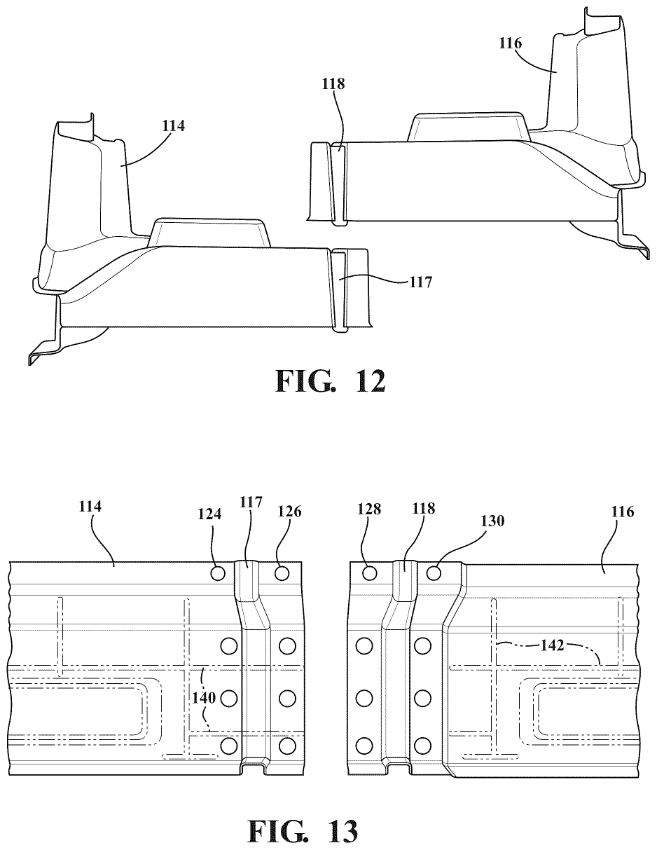

FIG. 12 presents a succeeding view to FIG. 11 and depicting the guiding features associated with the overlapping inter-engagement of the interlocking configurations (depicted by end configurations 117/118) which are configured in the opposing end profiles of the castings, and prior to overlapping engagement. FIG. 13 presents a plan view of the opposing interlocking end extension profiles 117/118 of FIG. 11 and further illustrates in phantom the underside ribbed structure of the castings which permit the overlapping engagement shown in FIG. 12. These are depicted by reinforced underside structural profiles of the castings 114/116, defined by arrangements of interconnecting ribs 140 for casting 114 which extend to an outermost end of the interlocking profile 117, along with interconnecting ribs 142 for casting 116 which terminate short of the interlocking profile 118, this to account for the overlapping engagement with opposing profile 116 during the downward overlapping and interlocking engagement of the casting 116 to the casting 114 shown in FIG. 12.

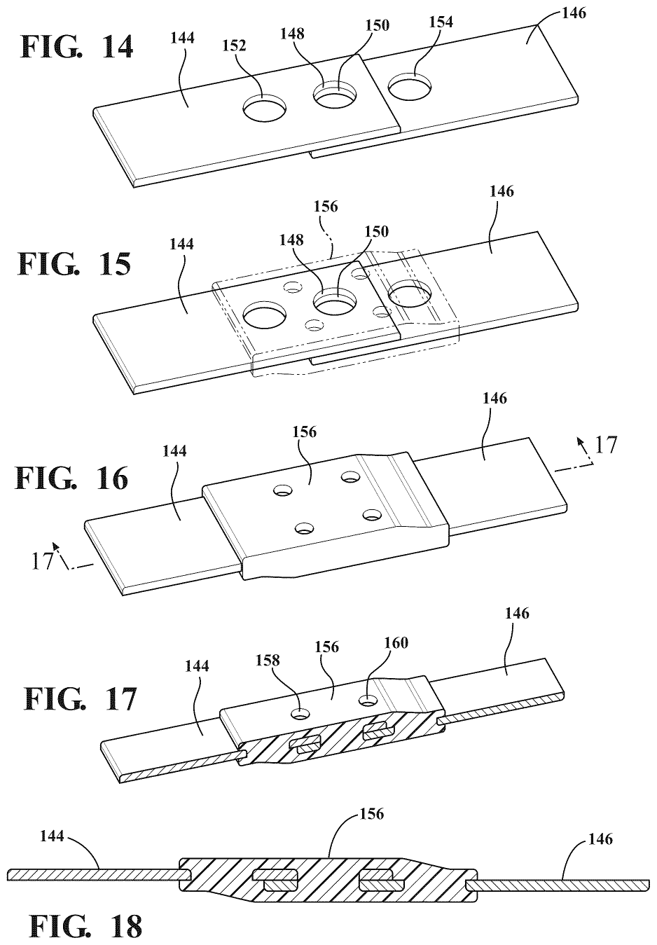

Proceeding now to FIGS. 14-24, presented are a succession of three dimensional and cutaway views showing a variety of overlapping interlocking profiles established between the end extensions of the first and second HPDC castings, and including depictions of flow-through of the injection molded plastic for establishing the hybrid structure. FIG. 14 presents a representation of a pair of overlapping aluminum casting flattened portions (also termed coupons) 144/146, and which exhibit any arrangement of apertures, holes, slots or the like. As shown, an overlapping and aligning pair of apertures (defined by rim edges 148/150) are configured in the aluminum coupons 144 and 146 additional to selected apertures 152 (coupon 144) and aperture 154 (coupon 146).

Proceeding to FIGS. 15-18, a succession of views are depicted of an injection molded plastic over-mold which is applied around the end-mated coupons 144/146 in order to encapsulate and flow through the defined aperture pattern. FIG. 15 depicts in phantom and FIG. 16 in solid the plastic over-mold 156, with FIG. 17 presented a cutaway along line 17-17 of FIG. 16 and further showing ejector pin holes 158/160 for removing the coupon/finished part from the injector mold after material solidification. FIG. 18 depicts a side plan of FIG. 17 again showing the plastic flow through of the material through the overlapping apertures 148/150 depicted in FIGS. 14-15.

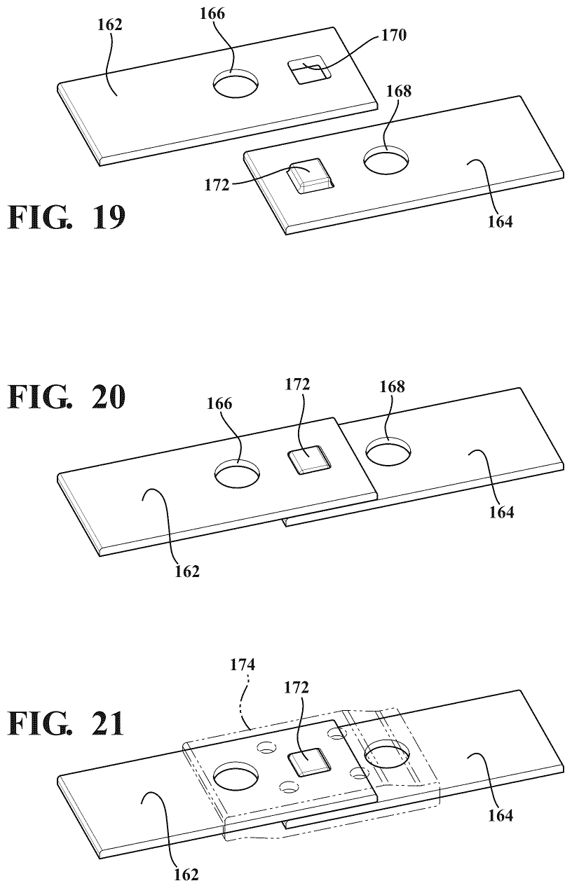

FIGS. 19-24 depict an alternate arrangement of end-mated aluminum castings/coupons, further at 162/164, including a similar arrangement of apertures 166/168 in combination with an end located key aperture 170 (in coupon 162) combined with an embossed tab 172 defined in the opposing end of coupon 164. FIG. 19 depicts this arrangement in exploded fashion, with FIG. 20 depicting the coupons in end-assembled and interlocking fashion. FIG. 21 depicts the over-molded plasticized material 174 which is applied to bond the components together.

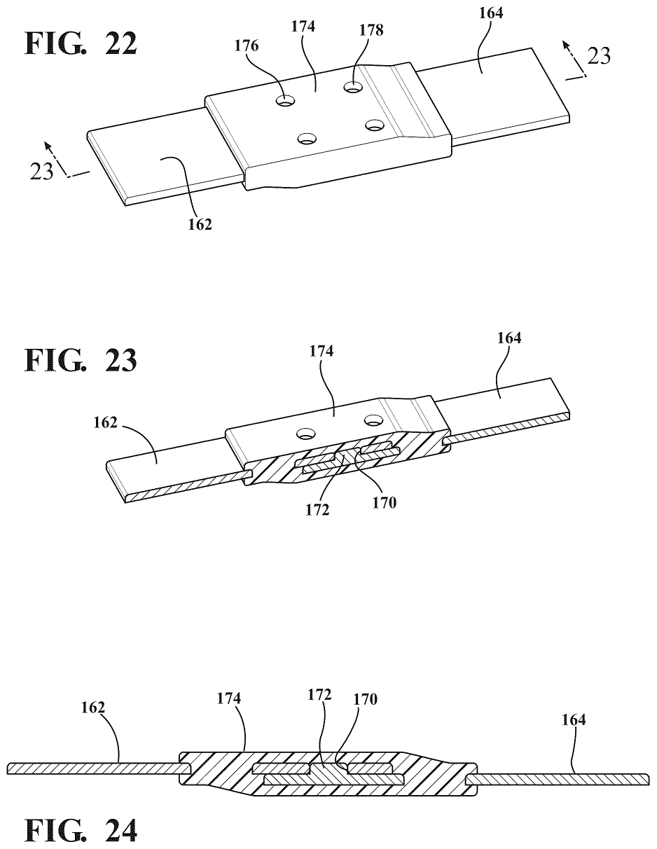

FIG. 22 presents a perspective view of the over-molded plasticized material, again including an arrangement of eject or pin locations 176/178 for assisting in removal of the finished part. FIG. 23 presents a cutaway view taken along line 23-23 of FIG. 22 and showing the seating engagement of the tab 172 through the aligning keyed recess 170 with FIG. 24 further depicting in side plan view the over-mold arrangement of FIG. 23.

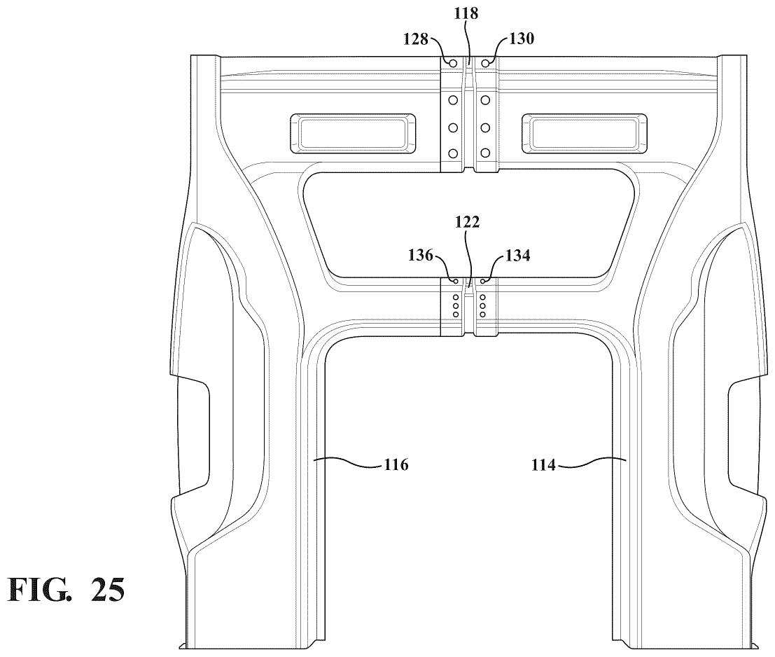

Proceeding to FIG. 25, an overhead plan view is shown of first and second HPDC components (as previously shown in exploded fashion at 114/116 in FIG. 11) arranged in overlapping engagement with interlocking profiles 118/122 and similar aligning apertures, prior to being secured to the mounting fixture and transferred to the IM press operation for introducing the plasticized material. This includes a similar arrangement of aligning apertures extending crosswise along the interlocking edges of the castings 116/118 for subsequent flow-through of the over-molded plasticized material for assisting in bolting together the castings along their reinforced molded areas.

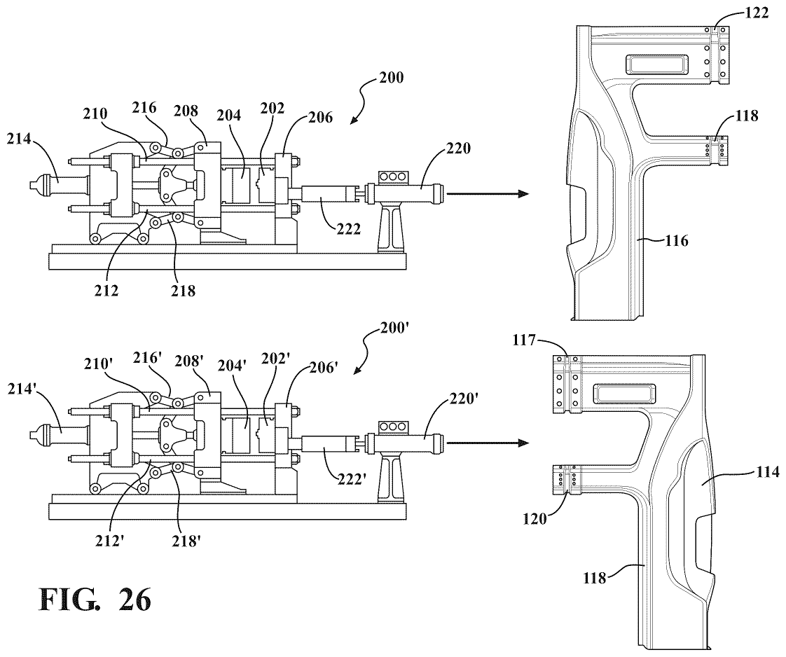

Proceeding now to FIGS. 26A-26B, depicted is an HPDC casting operation for producing each of first and second HPDC castings depicting the desired interlocking end profiles. As described herein, high pressure die casting operations are generally known, with the present invention advancing this technology through the formation of aluminum or like metal castings which exhibit the unique interlocking edge profiles for assisting in the eventual binding process utilizing the succeeding IM press or tool operation. The hybrid structure produced according to the present invention replaces prior mega-casting through the use of HDPC presses of under 5000 tons.

In a typical operation, a pair of HPDC presses (shown at 200 and 200′ for FIGS. 26A and 26B) are provided for forming each of the dedicated HPDC castings 116 and 114, this owing to uniqueness of the forming cavities associated with the opposing fixed die halves 202/202′ and moving die halves 204/204′ which respectively form the unique shapes of the castings 116/114 with the particular interlocking opposing end profiles and associated patterns of aligning holes, slots, passageways or the like for facilitating the binding together of the castings during the subsequent IM die press or tool operation.

As further shown, the remaining operating components of the HPDC presses 200/200′ are the same and are identically numbered. These include opposing platens 206/208 and 206′/208′ upon which are supported and displaced the fixed 202/202′ and movable 204/204′ die halves between open and closed positions for iteratively cycling the production of the castings. A plurality of four tie bars (two of which are shown at 210/212 and 210′/212′ respectively) support the platens and associated die halves with a machine closing cylinder 214/214′ actuating the moving die halves 204/204′ via machine locking toggle links 216/218 and 216′/218′.

Upon cycling the die halves to the closed position, a metal injection cylinder 220/220′ injects a suitable molten metal material (typically aluminum given its combination of strength and light weight however contemplating any suitable metal or alloy) into the closed cavities established between the mold halves. This is assisted by a plunger rod 222/222′ which communicates the injected molten metal into enclosed mold from the fixed die halves 202/202′ via an injection sleeve with metal pouring hold (not shown) for filling the respective mold cavities with the desired volume of material for forming the individual castings 114/116.

Proceeding to FIG. 27, presented is an exploded view of a three piece casting according to a non-limited alternate embodiment and depicting two outboard HPDC casted rails 250/252 connected to a third middle piece or casting 254 defining a close out panel. The interlock profile according to this variant includes jigsaw style interlocking end configurations depicted in non-limiting fashion by female jigsaw profiles 258 and 260 configured in end extended portions 262/264 which mate or assemble with male jigsaw profiles 266/268 configured along opposite edges of the middle casting 254.

Also depicted are additional jigsaw portions 270/272 extending inwardly from middle or intermediate locations of the castings 250/252 and which can receive additional crosswise extending castings or which can provide securement locations for a plasticized over-molded material applied in the succeeding IM operation. Without limitation, any dual lobe or other interconnecting profile is envisioned within the scope of the present invention for securing together the previously formed castings prior to the IM molding operation. This can further include integrated any of overlapping stepped surfaces, multi-axis interlock surfaces, dovetail shaped surfaces, tongue-and-groove shaped surfaced, tapered stepped surfaces, or undercut geometries.

FIG. 28 provides a further succeeding view to FIG. 27 and showing the jigsaw interlocking of the middle piece 254 to the end HPDC end rails 250/252. FIG. 29 presents a succeeding view to FIG. 28 and showing plastic over-molding (at 274) of the middle close-out panel 254 to the HPDC rails 250/252.

FIG. 30 depicts an isometric view, generally at 300, and showing an over-molding process/hybrid structure according to a further embodiment (which can be similar to the three piece rail arrangement of FIG. 29) and incorporating insert-molded fastening elements which can include, without limitation, any of threaded inserts or knurled nuts (at 302), studs or bosses (304), as well as any similar metallic components which may be positioned within the mold cavity of the IM press or tool prior to injection of the structural plastic (generally referenced at 306) such that the material encapsulates the inserts, thereby forming integrated attachment points within the hybrid structure which includes outer casting rails 308/310 and interconnecting middle rail or piece 312.

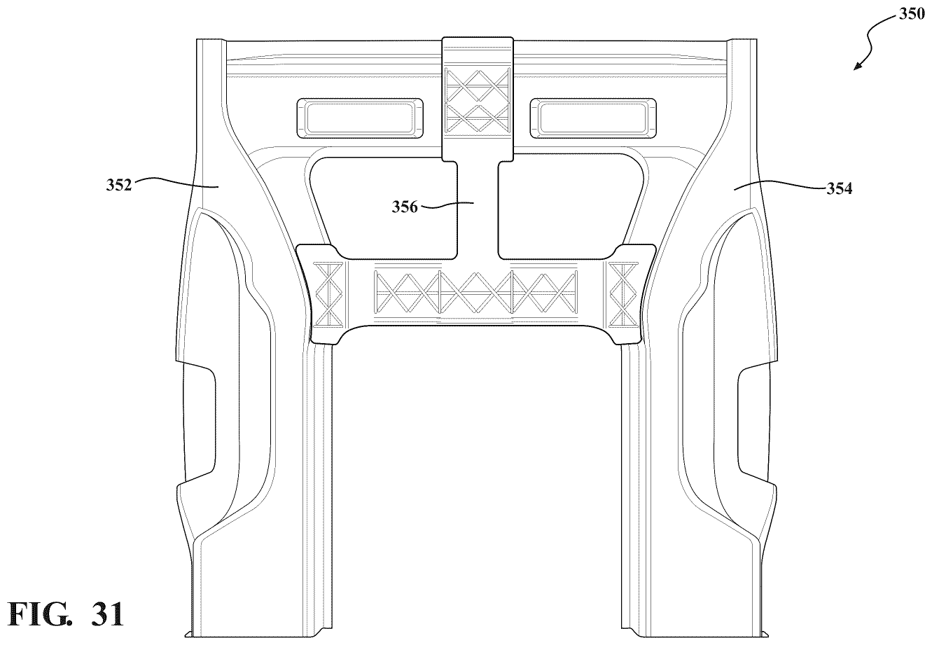

FIG. 31 presents an overhead plan view, generally at 350, of a variant of the present invention in which first 352 and second 354 “L” shaped castings are joined together with the over-molded plastic 356, which is depicted as a “T” shaped portion incorporating any ribbed or reinforcement structure and which binds together the outer casted rails both at intermediate locations as well as end joining/interlocked location, such as which can form either of continuous or semi-continuous longitudinal beams. The over-molded plasticized (e.g. nylon or like material) can alternatively be configured in any manner within the IM die tool or press operation such that it can substitute for specified crosswise castings in securing together the outer rails 352/354 according to any required structural application.

With reference to FIGS. 32-41, a series of views are provided of non-limiting embodiments for forming the IM over-molded material to the HPDC castings (see at 114/116 in FIG. 32). In a first option (FIGS. 32-37) the castings are fixtured to one half of the injection molding tool, with the entire mega-casting positioned inside the tie-bars.

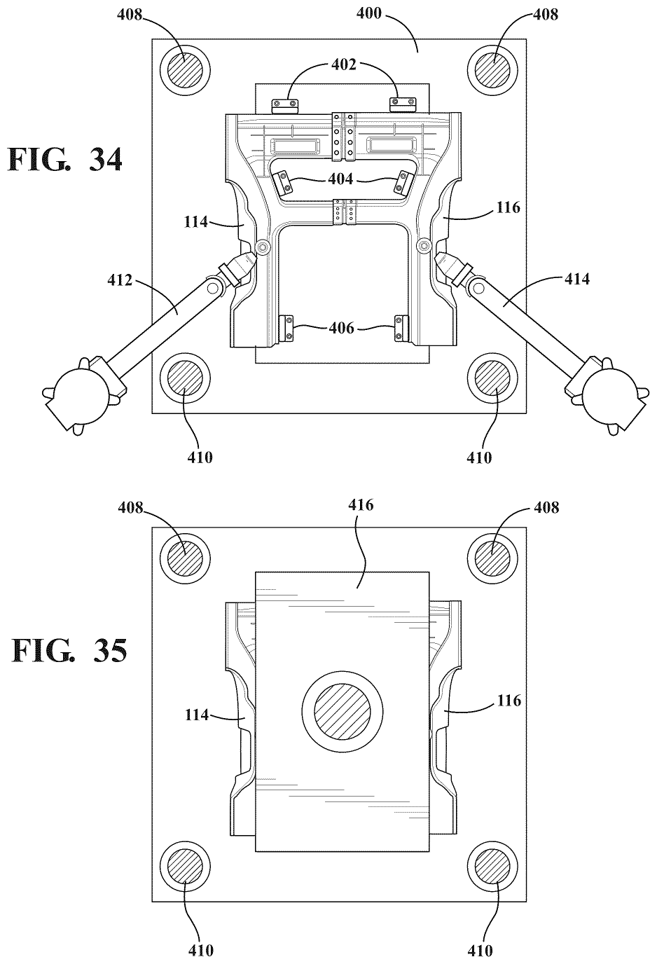

Prior to being over-molded, the castings are fixtured or secured to a first selected mating half of an injection mold tool (a first example of which is shown at 400 in FIG. 33) via any arrangement of clamps or fixtures, further shown at 402, 404, 406, et seq. Upper 408 and lower 410 pairs of tie bars are indicated which support the mating die tools or halves incorporated into the die press 20 representatively shown in FIGS. 1-2. FIG. 34 depicts a pair of robotic arms 412/414 and actuators for placement of the HPDC castings 114/116, such being successively placed corresponding to the previous description of FIG. 12 in which placement and fixturing of the first HPDC casting 114 is followed by alignment and downward placement of the second HPDC casting 116 within the mold press. Fixtures 402, 404, 406 again are provided in the form of suitable die clamps for securing the castings 114/116 upon the mold tool surface.

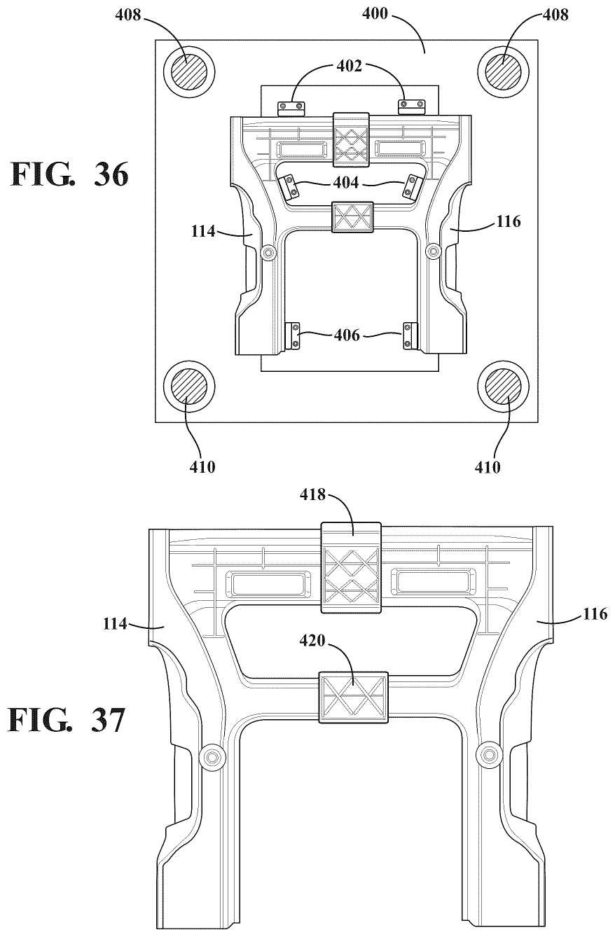

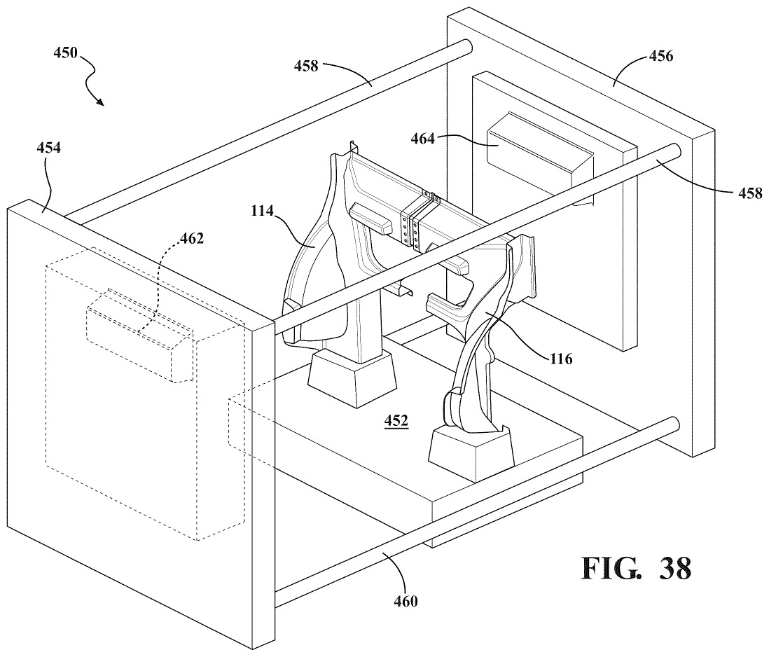

FIG. 35 depicts a succeeding view of FIG. 34 with the tool/press (see upper half 416) closed against the fixtured HPDC parts 114/116. At this point, the injection molding operation of the IM press 20 is conducted as previously described and described. FIG. 36 depicts a further succeeding view of the tool reopened to reveal the IM connection of the HPDC parts or components in order to form the hybrid structure. FIG. 37 depicts the hybrid structure of FIG. 36 removed from the mold to include interconnecting and over-molded portions 418 and 420 which can be formed at any of end or intermediate over-mold locations.

FIG. 38 presents a perspective view, generally at 450, of an alternate variant of over-molding operation in which the HPDC castings 114/116 are upright supported on a standalone fixture 452 located between the injection-mold tool halves (further represented at 454 and 456), with the entire mega-casting remaining inside of the assembly tie bars (upper shown at 458 and lower at 460). Opposing tool mold halves are respectively shown at 462 (phantom) and 464 (solid) corresponding to the tool halves 454/456. Although not shown, corresponding IM press molding structure is provided which introduces the pressurized and thermos-flowable plasticized material (e.g. nylon in a non-limiting application) within the selected receiving cavities associated with the mold halves 462/464 for forming the over-molded material upon the interlocking profiles established between the castings 114/116.

Proceeding to FIGS. 39-41, depicted is a third non-limiting IM operation in which the mega-casting illustrated extends outside of a redesign of tie bars (at 502/504) which are associated with a redesigned mold tool 506 incorporated into a redesigned injection mold press. As further, the HPDC castings 114/116 are sequentially transferred to the mold press support surface 506 (such as via the robotic arms and actuators previously described), whereupon they are sequentially affixed to the mold press 506 via the fixtures or clamps 508/510.

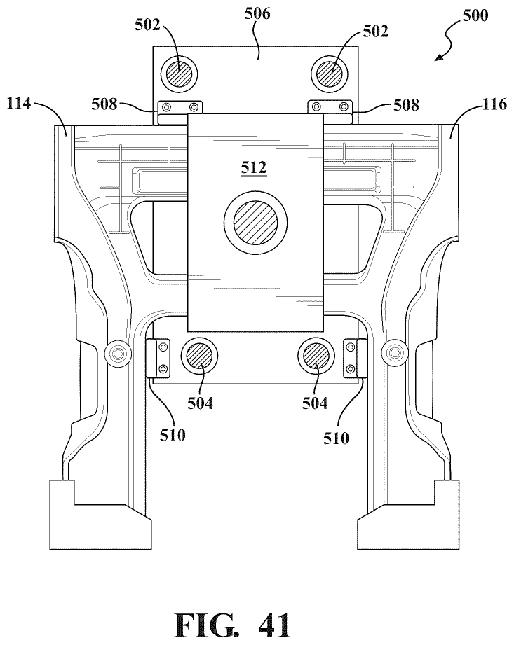

FIG. 40 presents a succeeding view to FIG. 39 depicting the HPDC castings 114/116 secured to the mold press 506 via mounting fixtures 508/510 prior to molding, with FIG. 41 presenting a further succeeding view to FIG. 40 with the second mold tool 512 applied over the fixtures supported HPDC castings 114/116 concurrent with the IM molding operation being commenced as previously described for forming the hybrid structure.

A related process is disclosed according to the assembly components previously described for joining a plurality of individual castings into a hybrid composite, and includes the steps of forming each of a first high pressure die cast HPDC component and a second HPDC component (such as again without limitation being fabricated from an aluminum or like metallic material), including forming interlock features in each of the components, positioning the first and second HPDC components in a fixtured arrangement in which the components define a predetermined alignment relative to one another and including engaging together the interlock features to mechanically couple the first and second HPDC components prior to molding, closing an injection molding tool around the fixtured HPDC components and injecting a structural plastic material into the molding tool such that the plastic material flows around, between, and through openings formed in the HPDC components to encapsulate the interlock features and to form an over-molded portion or joint securing the components together into a single hybrid structure.

The step of forming interlock features as previously depicted further includes forming any of overlapping stepped surfaces, multi-axis interlock surfaces, dovetail shaped surfaces, tongue-and-groove shaped surfaced, tapered stepped surfaces, or undercut geometries within the opposing end profiles of the castings. The step of forming openings in the HPDC components and also include forming any of through-holes or slots which are configured for plastic flow-through such that the molded plastic forms plastic “bolt-like” members for securing the components. The step of forming the interlock features as previously described and illustrated further includes orienting the features to resist separation along one or more axes and to serve as self-locating elements during fixturing of the HPDC components.

Other steps of the present process include over-molding exterior features including any of fascia mounts, sensor brackets, spare tire winch attachments, aero shield attachments, and interior features including any of storage tubs, spare-tire wells, load floor attachments, trim attachments, and seat attachments. The step of forming the first and second HPDC can further include forming the components on a die-casting press of less than 5000 tons.

Other steps include applying surface preparations including any of plasma, laser etching, chemical treatment or mechanical surface preparation to promote and applying heat, vibration, or pressure to promote bonding between the castings and over-molded material, with the step of injecting the structural plastic material into the molding tool further including over-molding the plastic material to integrate any of routing channels, wiring cavities, or attachment bosses. Other steps include configuring the injection molding tool to over-mold only a portion of the castings in a multi-shot or sequential molding operation. Yet additional features include positioning the first and second HPDC components in a fixtured arrangement as depicted in the embodiments of FIGS. 32-41 and further including aligning the HPDC components in order to form any of a vehicle frame, underbody, rear floor, front cradle, or battery tray.

As previously described, the present invention provides the additional benefit of eliminating the need for adhesives and additional mechanical fasteners, further including such as conventional welding, self-piercing rivets (or SPR's) for joining two or more layers of a material without the requirement of predrilled or punched holes, as well as flow drilling screws (FDS) for joining materials such as dissimilar aluminum alloys according to a thermal-mechanical joining process.

As also understood, combining smaller and midrange HPDC assemblies with injection molding applications provides for both cost and manufacturing efficiencies and avoids the need for massive or mega presses (such as requiring several thousand tons of force application and which are outside of the budget of many OEM's), as well as eliminating the need for traditional OEM body shop welding and joining techniques for fabricating together multiple parts.

The present invention accordingly provides an opportunity for utilization of existing large casting HPDC assets while achieving a single end item mega hybrid module/assembly through a unique process of insert-molding aluminum HPDC components in a plastic injection molding process for the purpose of achieving a single hybrid structure through the unique joining of two or more individual aluminum HPDC pieces. In this fashion, the present invention provides the ability to define a unique joint configuration of metal and plastic which includes metal-to-metal interface, as well as metal to plastic interface of the joined components.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure.

It is also to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A process for forming a hybrid structure, comprising the steps of:
forming each of a first high pressure die cast (HPDC) component and a second HPDC component;
positioning the first and second HPDC components in a fixtured arrangement in which the components define a predetermined alignment relative to one another established by interlocking features to mechanically couple the first and second HPDC components prior to molding;
closing an injection molding tool around the fixtured HPDC components; and
injecting a structural plastic material into the molding tool such that the plastic material flows around, between, and through openings formed in the HPDC components to encapsulate the interlock features and to form an over-molded portion securing the components together into a single hybrid structure.

2. The process for forming a hybrid structure of claim 1, wherein the step of positioning the first and second HPDC components further comprising the interlock features forming any of dual lobed jigsaw-style interlocking geometry, overlapping stepped surfaces, multi-axis interlock surfaces, dovetail shaped surfaces, tongue-and-groove shaped surfaced, tapered stepped surfaces, or undercut geometries.

3. The process for forming a hybrid structure of claim 1, further comprising the step of forming any of through-holes, slots or pathways in the first and second HPDC components which are configured for plastic flow-through such that the molded plastic forms plastic “bolt-like” members for securing the components.

4. The process for forming a hybrid structure of claim 1, further comprising the step of forming thru holes in the first and second HPDC components for securing any of close out plates, covers or tubs.

5. The process for forming a hybrid structure of claim 1, wherein said step of forming interlock features further comprising the step of orienting the features to resist separation along one or more axes and to serve as self-locating elements during fixturing of the HPDC components.

6. The process for forming a hybrid structure of claim 1, wherein the step of injecting the structural plastic material further comprises over-molding exterior features including any of fastener or fastener receiving nuts, fascia mounts, sensor brackets, spare tire winch attachments, aero shield attachments, and interior features including any of storage tubs, spare-tire wells, load floor attachments, trim attachments, and seat attachments.

7. The process for forming a hybrid structure of claim 1, wherein said step of forming the first and second HPDC further including forming the components on a die-casting press of less than 5000 tons.

8. The process for forming a hybrid structure of claim 1, further comprising the steps of applying surface preparations including any of plasma, laser etching, chemical treatment or mechanical surface preparation to promote and applying heat, vibration, or pressure to promote bonding between the castings and over-molded material.

9. The process for forming a hybrid structure of claim 1, wherein the step of injecting the structural plastic material into the molding tool further comprising over-molding the plastic material to integrate any of routing channels, wiring cavities, or attachment bosses.

10. The process for forming a hybrid structure of claim 1, further comprising the step of configuring the injection molding tool to over-mold only a portion of the castings in a multi-shot or sequential molding operation.

11. The process for forming a hybrid structure of claim 1, wherein the step of positioning the first and second HPDC components in a fixtured arrangement further comprising aligning the HPDC components in order to form any of a vehicle underbody, rear floor, front cradle, or battery tray.

12. A hybrid structure, comprising:
each of first and second HPDC components including opposing end interlock features which are engaged together to mechanically couple the components; and
a structural plastic material injected around, between, and through openings formed in the HPDC components, including to encapsulate the interlock features and to form an over-molded joint securing the components together into the hybrid structure.

13. The hybrid structure of claim 12, further comprising said injection molded plastic material forming structural ribs integrated into a crash-management structure for a vehicle.

14. The hybrid structure of claim 12 having a specified shape and size and including any of a vehicle underbody, rear floor, front cradle or battery tray.

15. The hybrid structure of claim 12, said structural plastic forming any of continuous or semi-continuous longitudinal beams in the structure.

16. The hybrid structure of claim 12, said interlock features further comprising any of dual lobed jigsaw-style interlocking geometry, overlapping stepped surfaces, multi-axis interlock surfaces, dovetail shaped surfaces, tongue-and-groove shaped surfaced, tapered stepped surfaces, or undercut geometries.

17. The hybrid structure of claim 12, further comprising any of through-holes or slots formed in the HPDC components which are configured for plastic flow-through such that the molded plastic forms plastic “bolt-like” members for securing the components.

18. The hybrid structure of claim 12, further comprising over-molded exterior features including any of fastener or fastener receiving nuts, fascia mounts, sensor brackets, spare tire winch attachments, aero shield attachments, and interior features including any of storage tubs, spare-tire wells, load floor attachments, trim attachments, and seat attachments.

19. An assembly for forming a hybrid vehicle structure comprising:
a die press for forming each of first and second HPDC components, including forming complementary interlock features on each of the first and second HPDC components which are configured to mechanically engage one another;
a fixture for positioning the first and second HPDC components in an arrangement in which the components define a predetermined alignment relative to one another with the interlock features mechanically coupling the first and second HPDC components; and
an injection molding tool configured to receive the fixture and inject a structural plastic material to flow around, between, and through openings formed in the HPDC components to encapsulate the interlock features and to form an over-molded joint securing the components together into a single hybrid structure.

20. The assembly of claim 19, further comprising said die press being rated less than 5000 tons.

21. The assembly of claim 19, further comprising said die press forming openings in said HPDC components including any of through-holes or slots which are configured for plastic flow-through such that the molded plastic forms plastic “bolt-like” members for securing the components.
